(19) United States
(12) Patent Application Publication
(10) Pub. No.: US 2026/0048857 A1
(43) Pub. Date: Feb. 19, 2026

(54) Temperature Control Systems In Base Stations For Unmanned Aerial Vehicles

(71) Applicant: Skydio, Inc., San Mateo, CA (US)

(72) Inventors: Emily Guo, San Mateo, CA (US); Yee Shan Woo, Campbell, CA (US); Phoebe Josephine Altenhofen, San Francisco, CA (US); George Oliver Turvey, Brookdale, CA (US); Patrick Allen Lowe, Palo Alto, CA (US); Yevgeniy Andreyevich Kozlenko, New Fairfield, CT (US); Hunter Celio, San Mateo, CA (US); Rahul Mulinti, Hillsborough, CA (US); Christopher Brian Grasberger, Burlingame, CA (US); Joseph Tankeh, Fremont, CA (US)

(21) Appl. No.: 19/239,182

(22) Filed: Jun. 16, 2025

Related U.S. Application Data
(60) Provisional application No. 63/683,514, filed on Aug. 15, 2024.

(51) Int. Cl. B64F 1/36; B64U 70/50; B64U 70/90

(52) U.S. Cl. CPC B64F 1/362; B64U 70/50; B64U 70/90

(57) ABSTRACT

A base station for a UAV including a temperature control system to regulate (e.g., lower or raise) the temperature of the UAV. The temperature control system includes: a heatsink stack; an intake duct, which defines a first air circuit that balances the temperature and the humidity within the base station; an ambient duct, which defines a second air circuit that directs air across a first end of the heatsink stack; and a treated duct which directs air across a second end of the heatsink stack to thereby thermally condition the air therein.

### CROSS-REFERENCE TO RELATED APPLICATION(S)

This application claims the benefit of and priority to U.S. Provisional Patent Application Ser. No. 63/683,514, filed on Aug. 15, 2024, the entire content of which is hereby incorporated by reference.

### TECHNICAL FIELD

The present disclosure relates to a base station for an unmanned aerial vehicle (UAV) and, more specifically, to a base station including a temperature control system that is configured to regulate the temperature of the UAV by heating and/or cooling a power source thereof.

### BACKGROUND

Base stations are utilized to service and accommodate UAVs during use, charging, and storage. Thermal management (e.g., heating, cooling, and/or humidity control) is a prerequisite for proper operation of both the base station and the UAV particularly in more severe environmental conditions and climates. For example, at extreme temperatures, the ability to charge the UAV and the time required to do so can be problematic.

To that end, the present disclosure provides a base station including a temperature control system that is configured to regulate the temperature of the UAV by heating and/or cooling a power source thereof in order to facilitate charging and decrease the downtime of the base station and the UAV.

### SUMMARY

The present disclosure describes a base station for a UAV including a temperature control system that is configured to regulate (e.g., lower or raise) the temperature of the UAV as well as corresponding methods of temperature regulation. The temperature control system includes: an intake duct; an ambient duct; a treated duct, which directs thermally conditioned air across the power source of the UAV; and a heatsink stack, which extends between the ambient duct and the treated duct.

The intake duct defines a first air circuit, which directs air into the base station in order to balance the temperature and the humidity therein, the ambient duct defines a second air circuit, which directs air across a first end of the heatsink stack, and the treated duct defines a third air circuit, which directs air across a second end of the heatsink stack, thereby thermally conditioning the air within the treated duct, and across the power source of the UAV. Whereas the first and second air circuits are generally open in that they communicate directly with the ambient (e.g., the external environment) and continuously draw air into and expel air therefrom, the third air circuit is closed in that it does not directly communicate with the ambient (e.g., the external environment). Instead, the third air circuit continuously recirculates the air therein.

The heatsink stack includes: first (e.g., lower) and second (e.g., upper) heatsinks, which extend into the ambient duct and the treated duct, respectively; (one or more) at least one thermoelectric conditioner (TEC), which is positioned (located) between the first and second heatsinks; and first and second fans, which draw air into the ambient duct and the treated duct, respectively.

The TEC(s) are each configured as a Peltier system such that upon activation of the heatsink stack, one end of the heatsink stack is heated and the other end of the heatsink stack is cooled.

### BRIEF DESCRIPTION OF THE DRAWINGS

The present disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a front, perspective view of a base station including a temperature control system according to the principles of the present disclosure and shown in a closed position.

FIG. 2 is a front, plan view of the base station.

FIG. 3 is a side, plan view of the base station.

FIG. 4 is a side, plan view of the base station shown in an open position.

FIG. 5 is a rear, plan view of the base station.

FIG. 6 is a partial, top, perspective view of the base station with a landing platform thereof shown in an open position.

FIG. 7 is a top, plan view of the landing platform.

FIG. 8 is a partial, top, plan view of the base station with the landing platform removed and illustrating the temperature control system.

FIG. 9 is a cross-sectional view taken along line 9-9 in FIG. 8.

FIG. 10 is a cross-sectional view taken along line 10-10 in FIG. 8.

FIG. 11 is a cross-sectional view taken along line 11-11 in FIG. 8.

FIG. 12 is a partial, cross-sectional view of the base station illustrating the temperature control system, which includes: an intake duct; an ambient duct; a heatsink stack; and a treated duct.

FIG. 13 is a partial, cross-sectional view of the landing platform.

FIG. 14 is a partial, bottom, perspective view of the landing platform.

FIG. 15 is a partial, top, perspective view of the temperature control system illustrating the ambient duct and the treated duct.

FIG. 16 is a partial, bottom, perspective view of the temperature control system illustrating the ambient duct and the treated duct.

FIG. 17 is a partial, side, perspective view of the temperature control system illustrating the ambient duct, the heatsink stack, and the treated duct.

FIG. 18 is a partial, side, perspective view of the temperature control system illustrating the ambient duct with parts shown separated, the heatsink stack, and the treated duct with parts shown separated.

FIG. 19 is a partial, top, perspective view of the temperature control system illustrating the ambient duct and the heatsink stack.

FIG. 20 is a partial, top, perspective view of the ambient duct and the heatsink stack.

FIG. 21 is a cross-sectional view taken along line 21-21 in FIG. 15.

FIG. 22 is a top, perspective view of the heatsink stack.

FIG. 23 is a partial, end, plan view of the temperature control system illustrating the ambient duct, the heatsink stack, and the treated duct.

FIG. 24 is a cross-sectional view taken along line 24-24 in FIG. 19.

FIG. 25 is a partial, top, plan view of the temperature control system illustrating the ambient duct and the heatsink stack.

FIG. 26 is a partial, cross-sectional view of the temperature control system illustrating an inlet conduit.

FIG. 27 is a partial, cross-sectional view of the temperature control system illustrating an outlet conduit.

### DETAILED DESCRIPTION

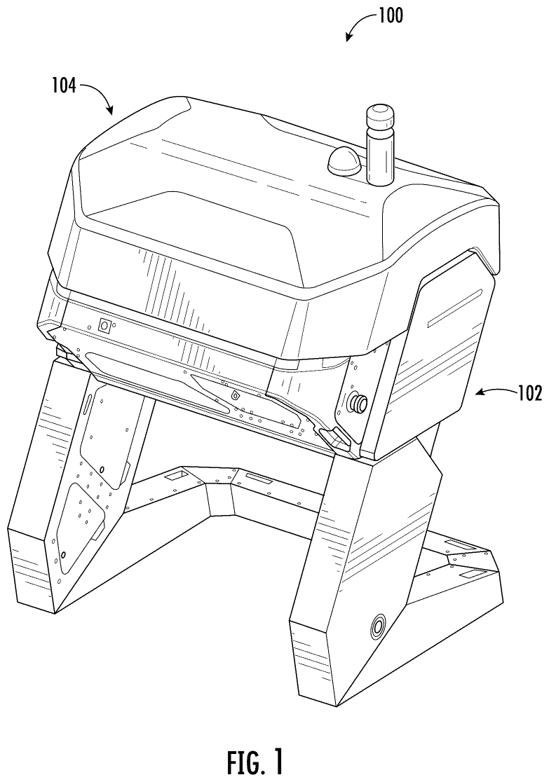

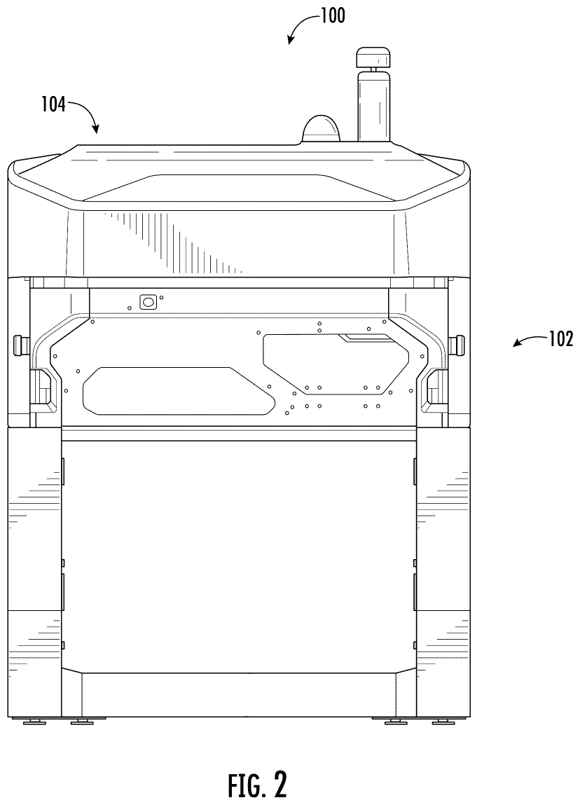

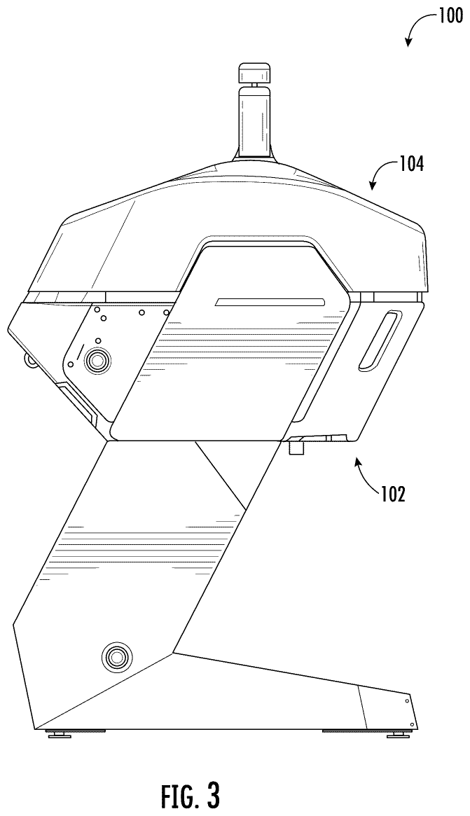

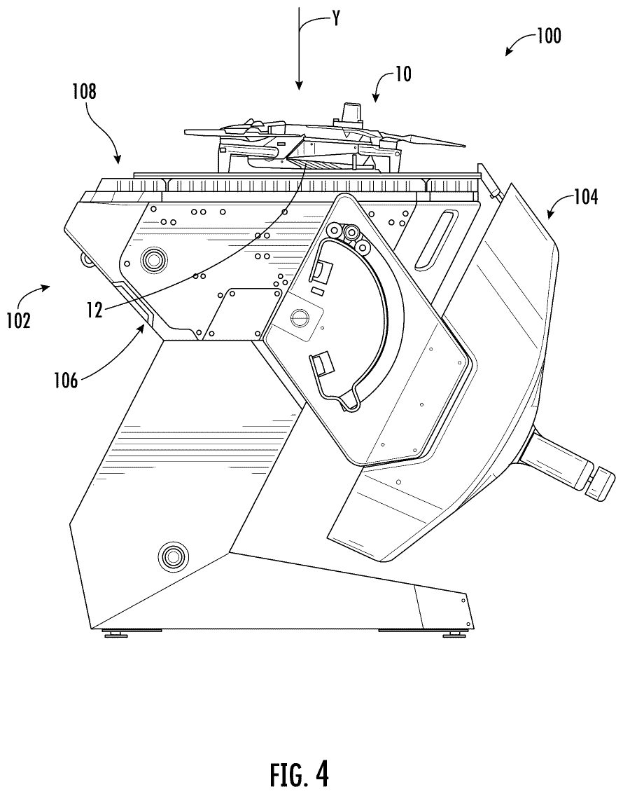

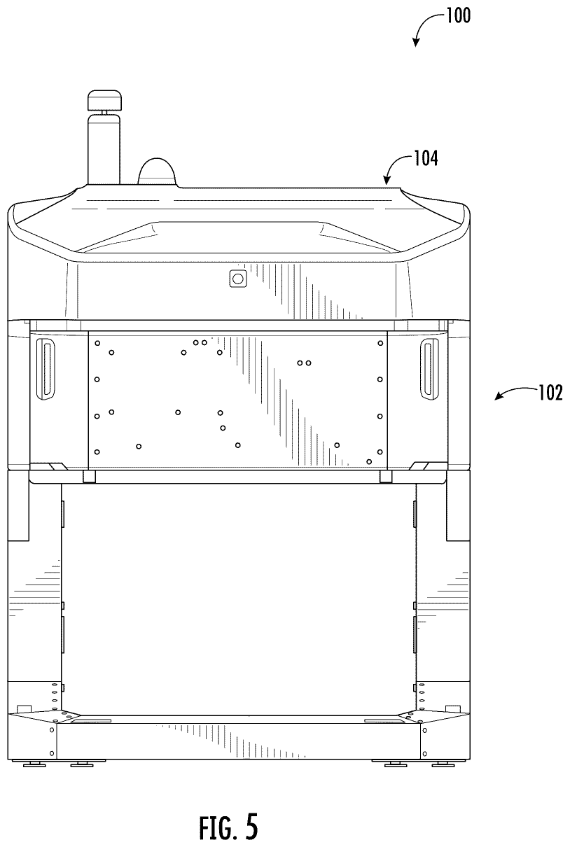

Referring now to the drawings, FIGS. 1-5 illustrate a base station 100 (also referred to as a dock) that is configured for automated servicing (e.g., storage, charging, operation, etc.) and accommodation of an unmanned aerial vehicle (UAV) 10 (FIG. 4) (e.g., a drone). While a single base station 100 and a single UAV 10 are shown and described herein, in certain embodiments of the disclosure, it is envisioned that a plurality of base stations 100 and a plurality of UAVs 10 may be deployed depending, for example, upon the particular intended use of the UAVs 10.

To support autonomous landing and docking of the UAV 10 with the base station 100, it is envisioned that the UAV 10 may follow any suitable process or procedure and may include any suitable electrical and/or logic components, as described in U.S. Pat. No. 11,873,116, the entire contents of which are hereby incorporated by reference.

The base station 100 includes a base 102 and a roof 104, which is supported by the base 102 such that the roof 104 and the base station 100 are repositionable between a closed position (FIGS. 1-3, 5), in which the base 102 and the roof 104 collectively define an enclosure that conceals the UAV 10 therein, and an open position (FIG. 4), which facilitates takeoff and landing of the UAV 10.

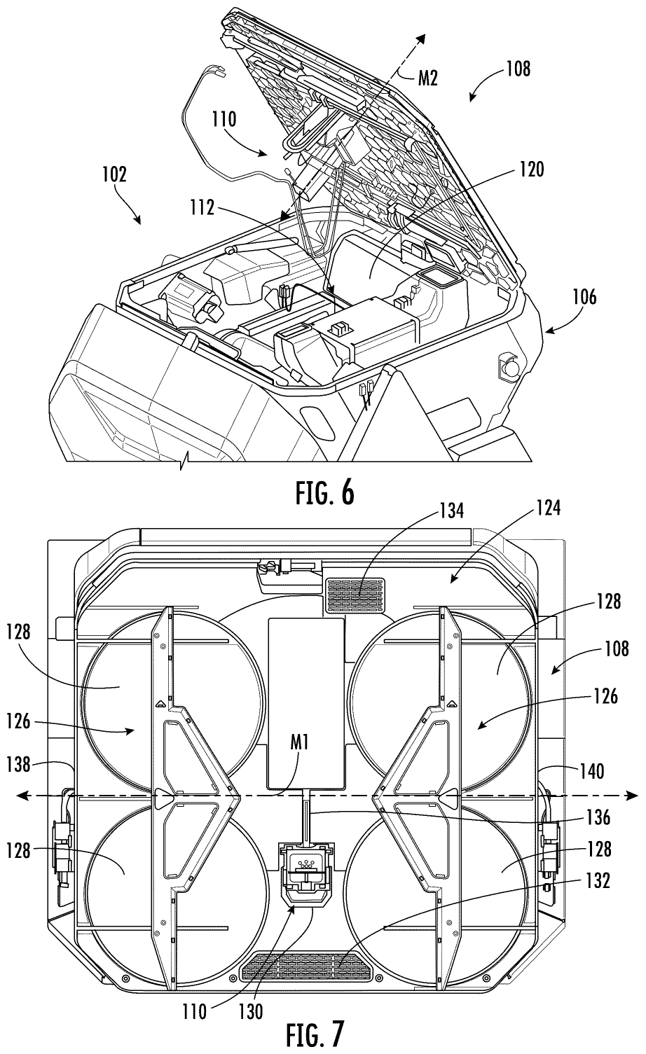

With reference now to FIGS. 6-11 as well, the base 102 includes: a body 106; a (reconfigurable) landing platform 108; a repositionable charging hub 110; and a temperature control system (also referred to as a thermal regulation system) that is configured to regulate (e.g., vary, raise and/or lower) the temperature of a power source 12 (e.g., a battery) of the UAV 10.

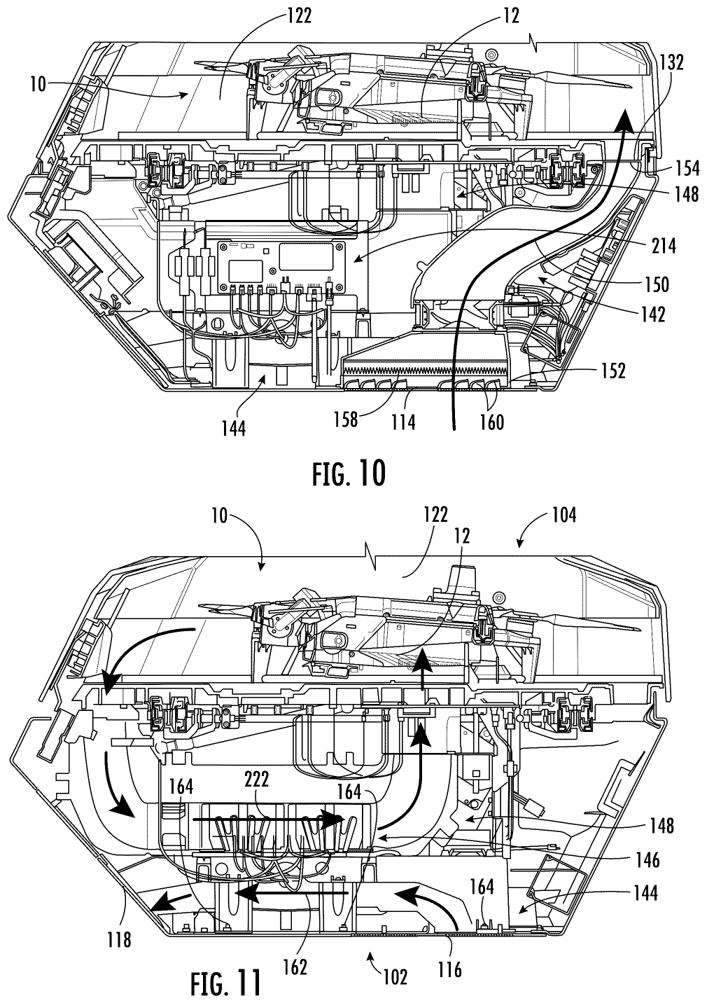

The body 106 is the main structural member of the base 102 and supports various internal and external components of the base station 100 including, for example, the roof 104, the landing platform 108, and the temperature control system 112. The body 106 includes: an air inlet 114 (FIG. 10) (also referred to as a first air inlet or vent); an air inlet 116 (FIG. 11) (also referred to as a second air inlet or vent); and an air outlet 118 (also referred to as a first air outlet or vent) which, collectively, allow air to enter, flow through, and exit the base station 100, as described in further detail below.

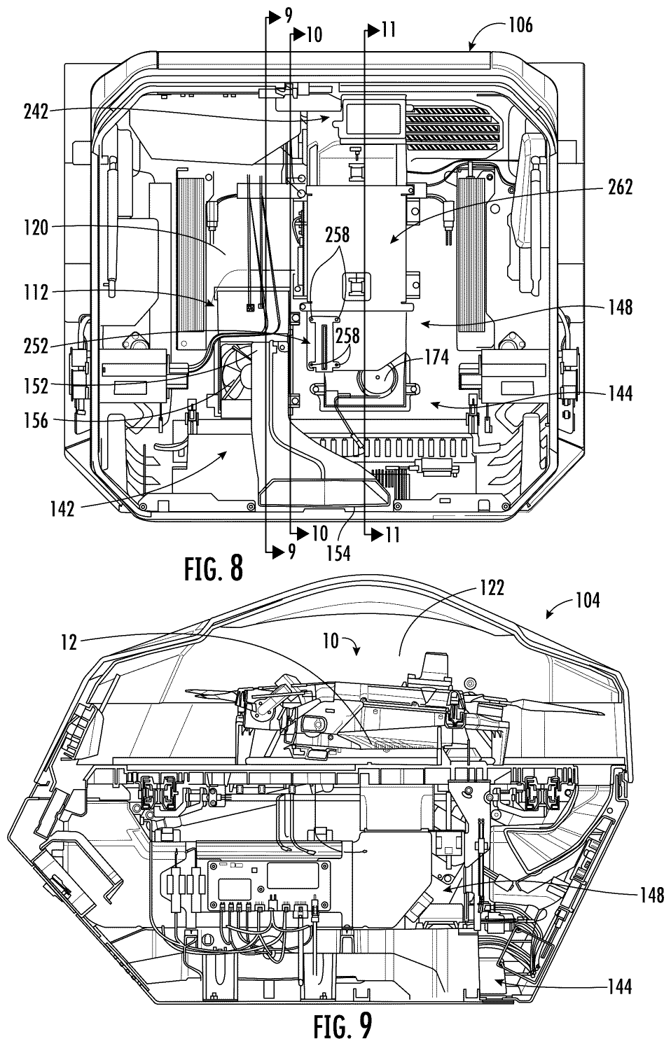

The landing platform 108 is supported by (e.g., connected (secured) to) the body 106 such that the body 106 and the landing platform 108 define a compartment 120 (FIGS. 6, 8) therebetween and such that the roof 104 and the landing platform 108 define a chamber 122 (FIGS. 9-11) therebetween, which is configured to accommodate the UAV 10 upon landing. The landing platform 108 is configured to receive the UAV 10 during docking and includes: a stage 124 and a pair of (first and second) alignment members 126.

The landing platform 108 is pivotably connected (secured) to the body 106 such that the landing platform 108 is repositionable between a closed position (FIG. 4), in which the landing platform 108 receives and accommodates the UAV 10, and an open position (FIG. 6), which provides access to various internal components of the base station 100. Embodiments in which the body 106 and the landing platform 108 may be non-pivotably connected (secured together) are also envisioned herein, however.

With reference to FIG. 7 in particular, the stage 124 is configured to receive the UAV 10 and defines a plurality of landing areas 128, which define the landing envelope for the UAV 10 (e.g., the space or the surface area on the landing platform 108 that is available to the UAV 10 during landing, docking, and takeoff). The stage 124 defines: a window 130; an air outlet 132 (also referred to as a second air outlet or vent); an air inlet 134 (also referred to as a third air inlet or vent); and an air outlet 136 (also referred to as a third air outlet or vent) which, collectively, further allow air to enter, flow through, and exit the base station 100, as described in further detail below.

The window 130 extends through the landing platform 108 and is generally aligned with the charging hub 110. The window 130 is configured to receive the charging hub 110 such that the charging hub 110 moves through the landing platform 108 via the window 130 during repositioning between retracted and extended positions.

The alignment members 126 are positioned (located) at opposite lateral ends 138, 140 of the landing platform 108 and are configured for engagement (contact) with the UAV 10. The alignment members 126 are movable (repositionable) in relation to the stage 124 between extended and retracted positions, which facilitates reconfiguration of the landing platform 108 between a first (landing) configuration and a second (charging) configuration, respectively. More specifically, during reconfiguration of the landing platform 108 between the first and second configurations, the alignment members 126 are movable (repositionable) along a generally horizontal axis of movement M1 that extends in generally orthogonal (perpendicular) relation to a generally vertical landing direction Y (FIG. 4) of the UAV 10.

When the landing platform 108 is in the first configuration, the alignment members 126 are in the extended position and are positioned laterally outward of the landing areas 128, which facilitates docking of the UAV 10 with the base station 100. When the landing platform 108 is in the second configuration, the alignment members 126 are in retracted position and are generally aligned with and are positioned vertically above the landing areas 128. During reconfiguration of the landing platform from the first configuration into the second configuration (e.g., during repositioning of the alignment members 126 from the extended position into the retracted position), the alignment members 126 are movable laterally inward (e.g., towards each other) along the axis of movement M1 and engage (contact) the UAV 10 in order to reposition (e.g., generally center) the UAV 10 on the landing platform 108 and generally align the power source 12 with the charging hub 110, thereby facilitating charging of the UAV 10.

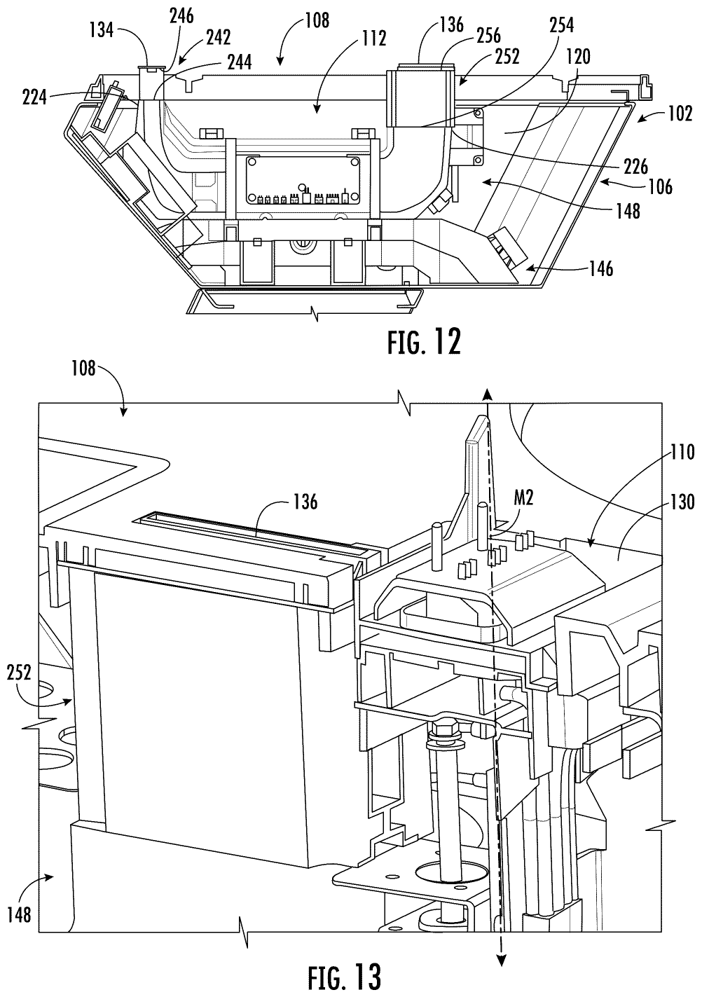

The charging hub 110 is configured for engagement (contact) with and electrical connection to the power source 12 (FIGS. 4, 9-11) on the UAV 10 and may draw power from any suitable source whether internal to the base station 100 (e.g., the main PCB in the base station 100) or external. The charging hub 110 is vertically repositionable between retracted and extended positions along a generally vertical axis of movement M2 (FIGS. 6, 13) (when the landing platform is in the closed position), which extends in generally parallel relation to the landing direction Y (FIG. 4) of the UAV 10 and in generally orthogonal (perpendicular) relation to the axis of movement M1 (FIG. 7).

Prior to landing of the UAV 10, the charging hub 110 is maintained in the retracted position such that the charging hub 110 is concealed by the landing platform 108. Concealing the charging hub 110 within the landing platform 108 facilitates docking of the UAV 10 by increasing the landing envelope, thereby reducing the precision required during landing and increasing the margin for error in order to increase the number of successful landings. Subsequent to landing and general alignment of the UAV 10 with the charging hub 110, which is discussed below, however, the charging hub 110 is repositioned into the extended position such that the charging hub 110 is exposed from and extends vertically through the landing platform 108 (e.g., the window 130) to facilitate connection to and charging of the UAV 10.

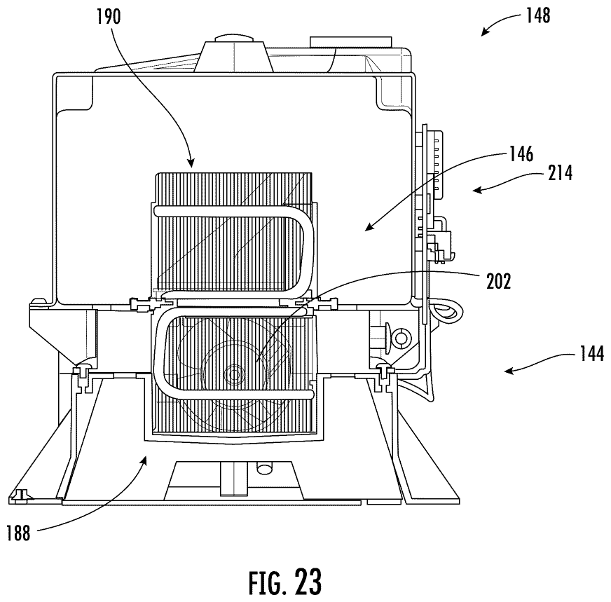

With reference now to FIGS. 12-27 as well, the temperature control system 112 will be discussed. The temperature control system 112 is supported by and retained (accommodated) within the base 102 (e.g., the body 106) and is positioned (located) within the compartment 120 such that the temperature control system 112 is concealed by the landing platform 108 when the landing platform is in the closed position. The temperature control system 112 is configured to thermally condition air within the base station 100 in order to regulate the temperature of the power source 12 of the UAV 10 which not only accommodates increases in the thermal mass thereof but decreases the amount of time that is required to charge the UAV 10 and, thus, downtime of the base station 100 and the UAV 10. For example, as described in further detail below, in warmer environments, the temperature control system 112 may be configured to cool the power source 12 of the UAV 10, whereas in cooler environments, the temperature control system 112 may be configured to heat the power source 12 of the UAV 10.

The temperature control system 112 includes: an intake duct 142 (FIGS. 8, 10) (also referred to as a first duct; an ambient duct 144 (also referred to as a second duct); a heatsink stack 146; and a treated duct 148 (also referred to as a third duct). As described in further detail below, the ambient duct 144 and the treated duct 148 collectively facilitate the circulation of thermally conditioned air through the chamber 122 in order regulate the temperature of the UAV 10 (e.g., by varying the temperature of the power source 12) and are arranged in a generally vertical orientation with the treated duct 148 being positioned (located) above the ambient duct 144.

The intake duct 142 defines an air circuit 150 (FIG. 10) (also referred to as a first air circuit) that draws air into the base station 100 and directs air therethrough (e.g., within the compartment 120 and the chamber 122) in order to balance temperature and humidity within the base station 100. In certain embodiments, it is also envisioned that the temperature control system 112 may include one or more sensors that are configured to detect and/or monitor temperature, humidity, etc., within the base station 100. As seen in FIG. 10, the air circuit 150 is generally open in that the air circuit 150 communicates directly with the ambient (e.g., the external environment) such that air is continuously drawn into and expelled from the air circuit 150.

The intake duct 142 is (directly) connected (secured) to the body 106 and includes opposite ends 152, 154 (also referred to as first and second ends, respectively); an intake fan 156; and a filter 158 in order to inhibit (if not entirely prevent) the entry of dust, debris, etc., into the base station 100 through the intake duct 142.

The end 152 of the intake duct 142 is in communication with the air inlet 114 such that air is drawn into the intake duct 142 therethrough, and the end 154 of the intake duct 142 is in communication with the air outlet 132 (FIGS. 7, 10) such that air exits the intake duct 142 and enters the chamber 122 therethrough. As seen in FIG. 10, the air inlet 114 includes baffles 160, which decrease the velocity of the air flowing through the air inlet 114 and act as splash guard.

The intake fan 156 is configured and positioned to simultaneously direct (draw) air from the ambient through the intake duct 142 and into both the body 106 (e.g., the compartment 120) and the chamber 122 (e.g., via the air outlet 132). In order to support this dual functionality, the intake fan 156 is laterally offset from the end 152 of the intake duct 142, as seen in FIG. 8, such that a first region (portion, half) of the intake fan 156 directs air into the compartment 120 and a second region (portion, half) of the intake fan 156 directs air into the intake duct 142.

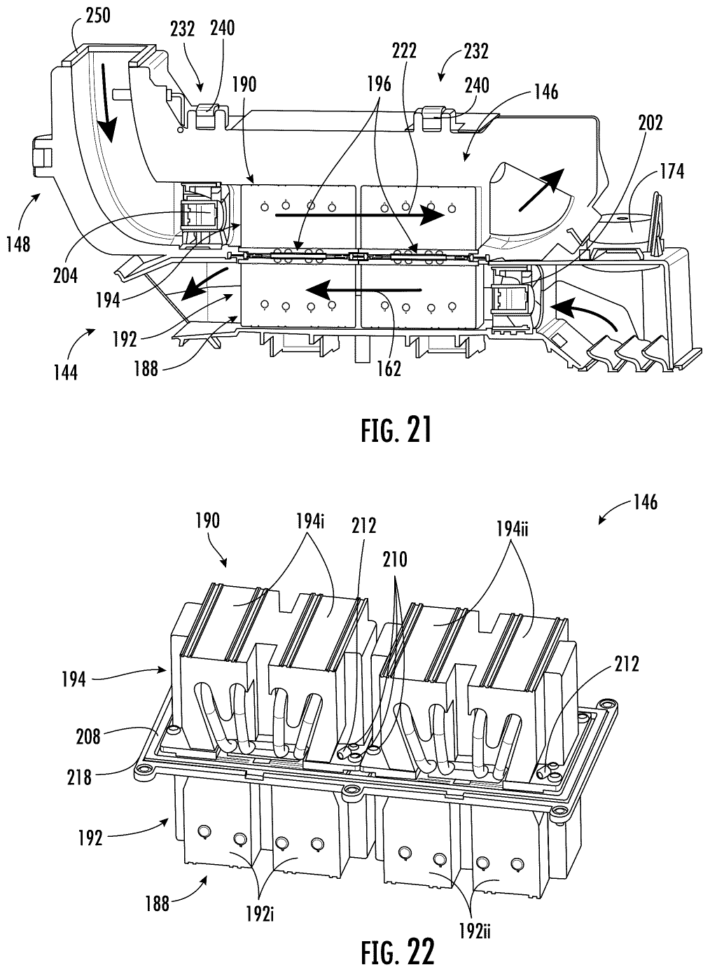

The ambient duct 144 defines a (second) air circuit 162 (FIGS. 11, 21) that draws air into the base station 100 and directs air and across the heatsink stack 146 to remove heat therefrom in order to facilitate the thermal conditioning of air within the treated duct 148, as described in further detail below. Like the air circuit 150, the air circuit 162 is generally open in that the air circuit 162 communicates directly with the ambient (e.g., the external environment) such that air is continuously drawn into and expelled from the air circuit 162.

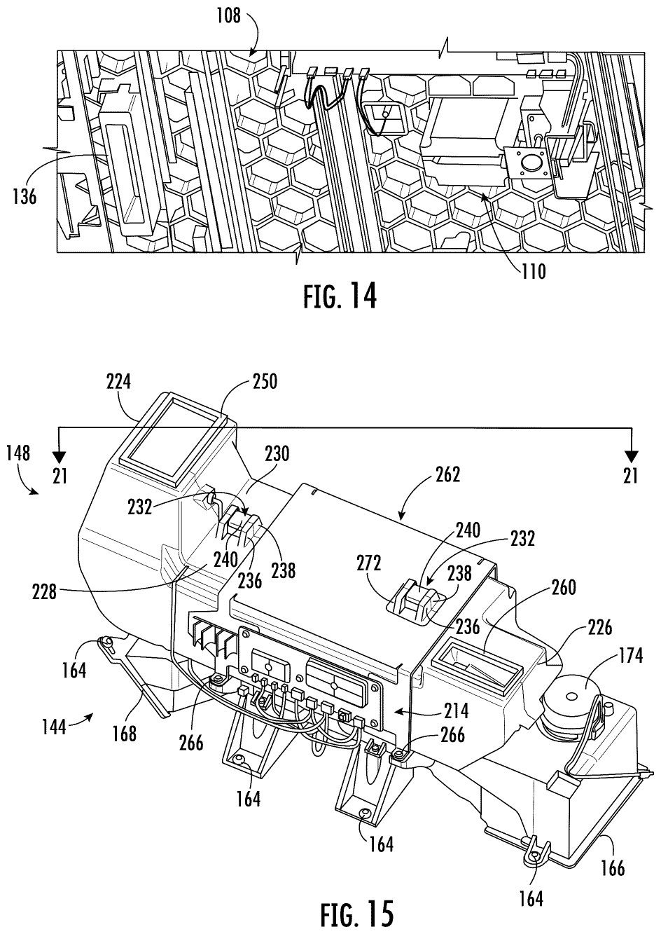

The ambient duct 144 is (directly) connected (secured) to the heatsink stack 146 and to the base 102 (e.g., the body 106). More specifically, the heatsink stack 146 extends into the ambient duct 144 and, in the illustrated embodiment, is connected (secured) thereto via crush ribs, and the ambient duct 144 is mechanically connected (secured) to the base 102 (e.g., the body 106) via fasteners 164 (FIGS. 11, 15), which provides structure to and increases the strength and the rigidity of the temperature control system 112.

The ambient duct 144 includes: an end 166 (also referred to as a first end), which is in communication with the air inlet 116 such that air is drawn into the ambient duct 144 therethrough; an end 168 (also referred to as a second end), which is in communication with the air outlet 118 such that (heated) air exits the ambient duct 144 and is expelled (exhausted) from the base station 100 therethrough; a duct portion 170 (also referred to as a first duct portion); a duct portion 172 (also referred to as a second duct portion); and a speaker 174.

The duct portions 170, 172 are configured as separate, discrete components of the ambient duct 144 and are (directly) mechanically connected (secured) together via fasteners 176 (FIG. 20) along an interface 178, which extends in a generally horizontal orientation.

The ambient duct 144 (e.g., the duct portions 170, 172) are non-insulated and include (e.g., are formed partially or entirely from) polycarbonate, which further facilitates the dissipation of heat from the heatsink stack 146 and from the air flowing through the ambient duct 144.

The duct portions 170, 172 include corresponding mating features 180, 182 (FIG. 17) (e.g., recesses and detents 184, 186), respectively. The mating features 180, 182 not only facilitate alignment of the duct portions 170, 172 during assembly of the ambient duct 144 but inhibit (if not entirely prevent) gapping between the duct portions 170, 172 and, thus, any loss of airflow through the ambient duct 144.

The speaker 174 is supported on the duct portion 172 such that the speaker 174 extends therethrough and is configured to facilitate communication between the base station 100 and a user. For example, it is envisioned that the speaker 174 may be utilized to provide various audible alerts and/or warnings to the user.

The heatsink stack 146 is configured to thermally condition (e.g., cool or heat) the air circulated within the treated duct 148 and includes: an end 188 (also referred to as a first or lower end); an end 190 (also referred to as a second or upper end); (one or more) at least one heatsink 192 (also referred to as a first or lower heatsink); at least one heatsink 194 (also referred to as a second or upper heatsink); (one or more) at least one thermoelectric conditioner (TEC) 196 with a hot end 198 (also referred to as a first end) and a cold end 200 (also referred to as a second end); a fan 202 (also referred to as a first or lower fan); and a fan 204 (also referred to as a first or lower fan).

The heatsink stack 146 operatively (indirectly) connects the ambient duct 144 and the treated duct 148 and extends therebetween. More specifically, the end 188 of the heatsink stack 146 is (directly) connected (secured) to and extends into the ambient duct 144 such that air directed through the ambient duct 144 flows across the end 188 of the heatsink stack 146, and the end 190 of the heatsink stack 146 is (directly) connected (secured) to and extends into the treated duct 148 such that air circulated within the treated duct 148 flows across the end 190 of the heatsink stack 146.

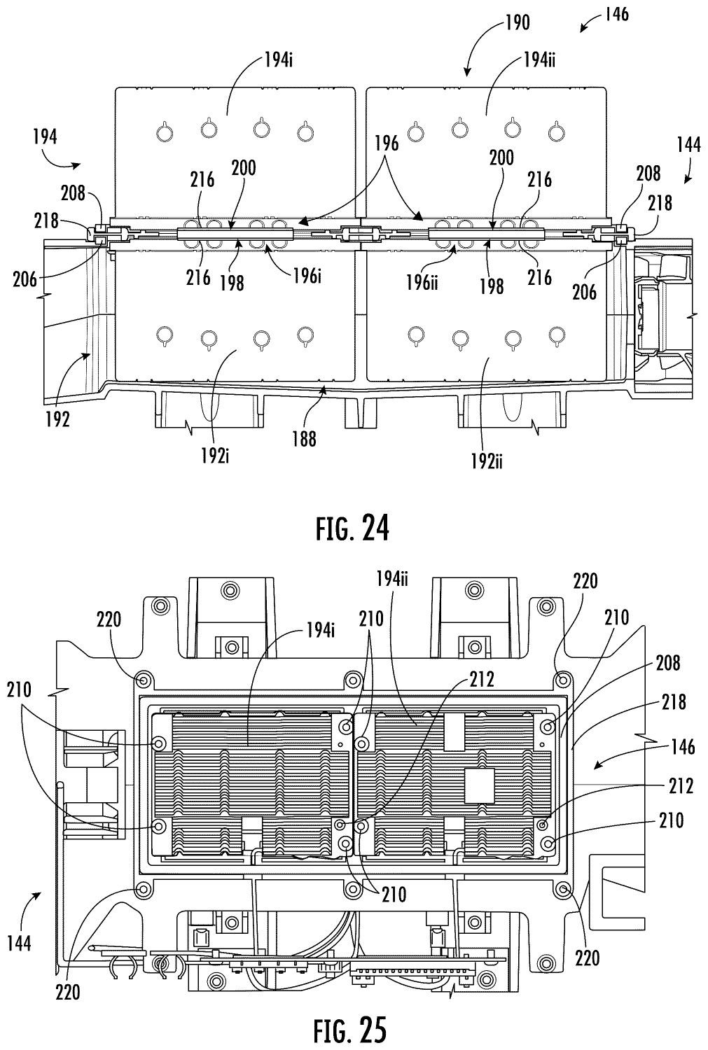

In order to inhibit (if not entirely prevent) gapping between the heatsink stack 146, the ambient duct 144, and the treated duct 148, the temperature control system 112 includes a seal 206 (FIGS. 24, 25) (also referred to as a first or lower seal or damper) and a seal 208 (also referred to as a second or upper seal or damper).

The seal 206 is positioned (located) between and engages (contacts) the heatsink stack 146 and the ambient duct 144. The seal 206 inhibits (if not entirely prevents) any loss of airflow through the ambient duct 144 as well as the entry of dust, debris, etc., into the base station 100 through the ambient duct 144.

The seal 208 is positioned (located) between and engages (contacts) the heatsink stack 146 and the treated duct 148. The seal 208 inhibits (if not entirely prevent) any loss of airflow through the treated duct 148 and, thus, the thermally conditioned air circulated therein.

In addition to inhibiting (if not entirely preventing) any loss of airflow through the ambient duct 144 and/or the treated duct 148, the seals 206, 208 each provide a damping effect that allows for relative movement between the heatsink stack 146 and the ambient duct 144 as well as relative movement between the heatsink stack 146 and the treated duct 148.

The heatsinks 192, 194 are (directly) mechanically connected via fasteners 210 (FIGS. 22, 25) and are positioned (located) adjacent to the TEC(s) 196 on opposite sides thereof such that the TEC(s) 196 are supported by the heatsinks 192, 194 and are positioned (located) between the ends 188, 190 of the heatsink stack 146. More specifically, as seen in FIG. 24, the heatsink 192 interfaces with (e.g., engages (contacts)) the hot end(s) 198 of the TEC(s) 196, and the heatsink 194 interfaces with (e.g., engages (contacts)) the end 200 of the TEC(s) 196 whereby the heatsinks 192, 194 distribute heat away from the TEC(s) 196 to facilitate the operation thereof, as discussed in further detail below.

The heatsinks 192, 194 include thermocouples 212 (FIGS. 22, 25), which are (directly) connected (secured) thereto in order to monitor the temperatures of the heatsinks 192, 194 and relay thermal information to the base station 100 (e.g., a main logic board) for processing. In the illustrated embodiment, the thermocouples 212 threadably engage (contact) the heatsinks 192, 194. It is envisioned, however, that the heatsinks 192, 194 and the thermocouples 212 may be connected (secured) together in any suitable manner.

In the illustrated embodiment, the temperature control system 112 includes four heatsinks 192i, 192ii, 194i, 194ii (e.g., two first or lower heatsinks and two second or upper heatsinks), which are generally identical in configuration. Embodiments in which the particular number of heatsinks 192, 194 may be increased or decreased are also envisioned herein, however (e.g., depending upon the size of the UAV 10, the size of the base station 100, thermal requirements, etc.).

The TEC(s) 196 are positioned (located) between the heatsinks 192, 194. As such, in the illustrated embodiment, the temperature control system 112 includes two TECs 196i, 196ii (e.g., first and second TECs, respectively). More specifically, the TEC 196i is positioned (located) between the heatsinks 192i, 194i, and the TEC 196ii is positioned (located) between the heatsinks 192ii, 194ii. Embodiments in which the particular number of TECs 196 may be increased or decreased are also envisioned herein, however (e.g., depending upon the size of the UAV 10, the size of the base station 100, thermal requirements, etc.). For example, embodiments in which the temperature control system 112 may include a single TEC 196 or three or more TECs 196 would not be beyond the scope of the present disclosure.

The TECs 196 are (directly) connected (secured) to a printed circuit board assembly (PCBA) 214 (FIGS. 15, 17, 23), which may draw power from any suitable source (e.g., the main logic board of the base station 100). The PCBA 214 is configured to deliver power to and thereby activate the heatsink stack 146 (e.g., the TECs 196) as well as regulate the operation thereof.

It is envisioned that the PCBA 214 may be configured and utilized to achieve any necessary or desired temperature for the air that is circulated through the chamber 122. For example, it is envisioned that the PCBA 214 may be configured to automatically vary (e.g., increase or decrease) and/or reverse current flow through the TECs 196 (e.g., based upon a measured temperature within the chamber 122 and/or a measured temperature of the power source 12 of the UAV 10), as described in further detail below.

The TECs 196 are each configured as a Peltier system that includes a dedicated (e.g., integrated) power source. In the illustrated embodiment, the base station 100 is intended for deployment in a warmer environment and, as such, the temperature control system 112 is configured such that the hot ends 198 of the TECs 196 are thermally and/or (directly) physically connected (secured) to the heatsinks 192 and, thus, the end 188 of the heatsink stack 146 in order to increase the temperature thereof, and such that the cold ends 200 of the TECs 196 are thermally and/or (directly) physically connected (secured) to the heatsinks 194 and, thus, the end 190 of the heatsink stack 146 in order to decrease the temperature thereof. It is envisioned, however, that the base station 100 may be configured for use in a variety of environments. As such, embodiments are envisioned in which the configuration of the temperature control system 112 (e.g., the heatsink stack 146) may be altered in order to vary the temperatures of the ends 188, 190 of the heatsink stack 146 in any necessary or desired manner. For example, as discussed in further detail below, when the base station 100 is intended for deployment in a cooler environment, the temperature control system 112 may be configured to decrease the temperature of the end 188 of the heatsink stack 146 and increase the temperature of the end 190 of the heatsink stack 146.

With reference now to FIGS. 22, 24, 25, in the illustrated embodiment, the heatsink stack 146 further includes thermal interface material (TIM) 216 and a spacer 218.

The TIM 216 is positioned (located) between the heatsinks 192, 194 and the TECs 196. The TIM 216 inhibits (if not entirely prevents) gapping between the heatsinks 192, 194 and the TECs 196 in order to improve heat conduction therebetween.

The spacer 218 is positioned (located) between the seals 206, 208. More specifically, the spacer 218 is (directly) mechanically connected (secured) to the ambient duct 144 via fasteners 220 (FIG. 25), which further connects (secures) the heatsink stack 146 to the ambient duct 144 and apply a compressive force to the seal 206. The spacer 218 not only provides structure to and increases the strength and the rigidity of the temperature control system 112 (e.g., the interface between the heatsink stack 146, the ambient duct 144, and the treated duct 148) but acts as a compression limiter for the TIM 216 as well as an insulator in order to maintain a temperature gradient between the heatsinks 192, 194 and inhibit heat transfer therebetween.

Upon activation of the heatsink stack 146, as current flows through the TECs 196, the temperature of the hot ends 198 increases (e.g., to an upper temperature threshold) while the temperature of the cold ends 200 decreases (e.g., to a lower temperature threshold) until a predetermined, fixed temperature differential is realized. Consequently, by reducing the upper temperature threshold, a corresponding reduction in the lower temperature threshold can be realized.

In the illustrated embodiment, the TECs 196 are configured such that the temperature differential lies substantially within the range of (approximately) 30° C. to (approximately) 70° C. Embodiments in which the TECs 196 may be configured such that the temperature differential lies outside of the disclosed range are also envisioned herein, however (e.g., depending upon the size of the UAV 10, the size of the base station 100, thermal requirements, etc.).

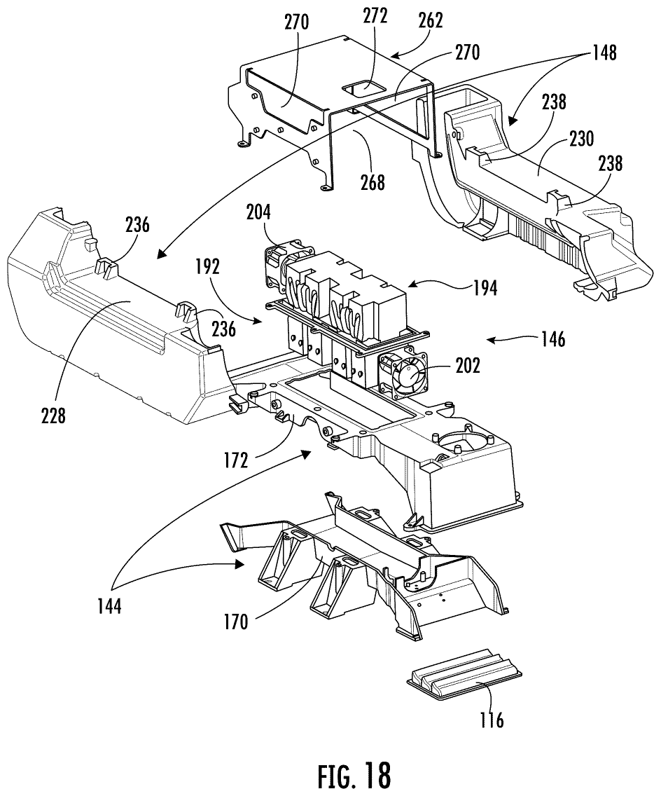

The fan 202 (FIG. 18) extends into and is positioned within the ambient duct 144, and the fan 204 extends into and is positioned within the treated duct 148. More specifically, the fan 202 is (directly) connected (secured) to the ambient duct 144 via crush ribs. The fan 202 directs (draws) air into the ambient duct through the air inlet 116 (FIG. 11), and the fan 204 draws air into the treated duct 148 through the air inlet 134 (FIG. 7) and circulates thermally conditioned air through the chambers 122 and within the treated duct 148. As seen in FIG. 18, the fans 202, 204 are oriented and are configured to direct air in generally opposite directions (e.g., such that the fans 202, 204 direct air in first and second directions, respectively).

The treated duct 148 defines a (third) air circuit 222 (FIG. 11) that directs (circulates) thermally conditioned air within the chamber 122 and across the UAV 10 in order to regulate the temperature of the power source 12, as indicated above. In contrast to the air circuits 150, 162, the air circuit 222 is generally closed in that the air circuit 222 is devoid of any direct communication with the ambient (e.g., the external environment). Rather, the air circuit 222 continuously recirculates (and thermally conditions) the air within the base station 100 (e.g., the chamber 122).

The treated duct 148 is (directly) connected (secured) to the landing platform 108, as described in further detail below, and is (indirectly) connected (secured) to the ambient duct 144 via the heatsink stack 146, as indicated above. The treated duct 148 includes: an end 224 (also referred to as a first end), which is in communication with the air inlet 134 such that air within the chamber 122 is drawn into the treated duct 148 therethrough for thermal conditioning; an end 226 (also referred to herein as a second end), which is in communication with the air outlet 136 such that thermally conditioned air exits the treated duct 148 therethrough; a duct portion 228 (also referred to as a first duct portion); and a duct portion 230 (also referred to as a second duct portion).

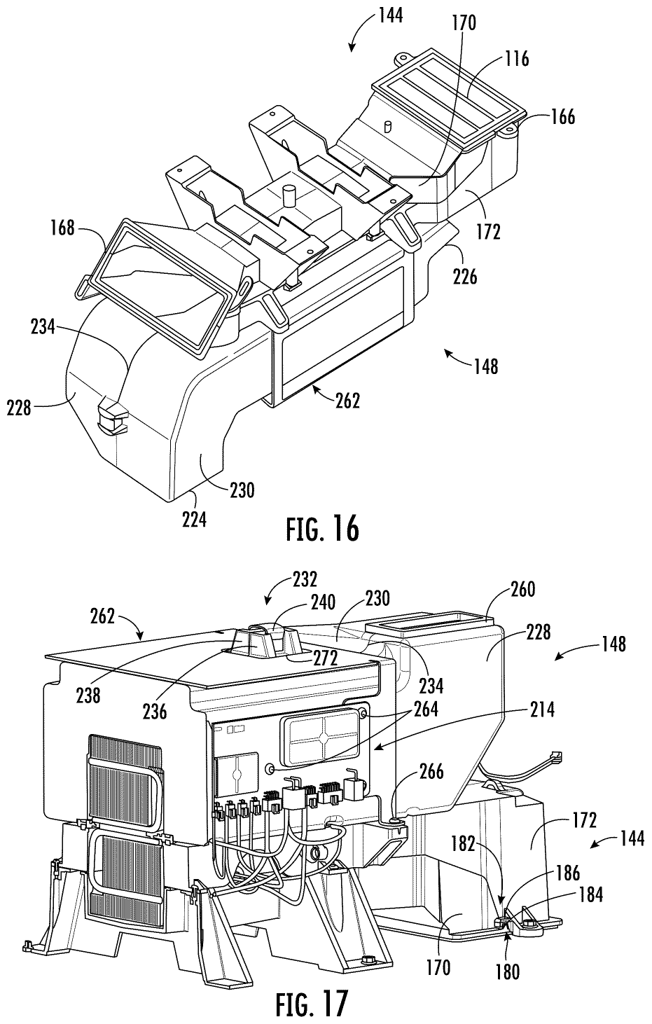

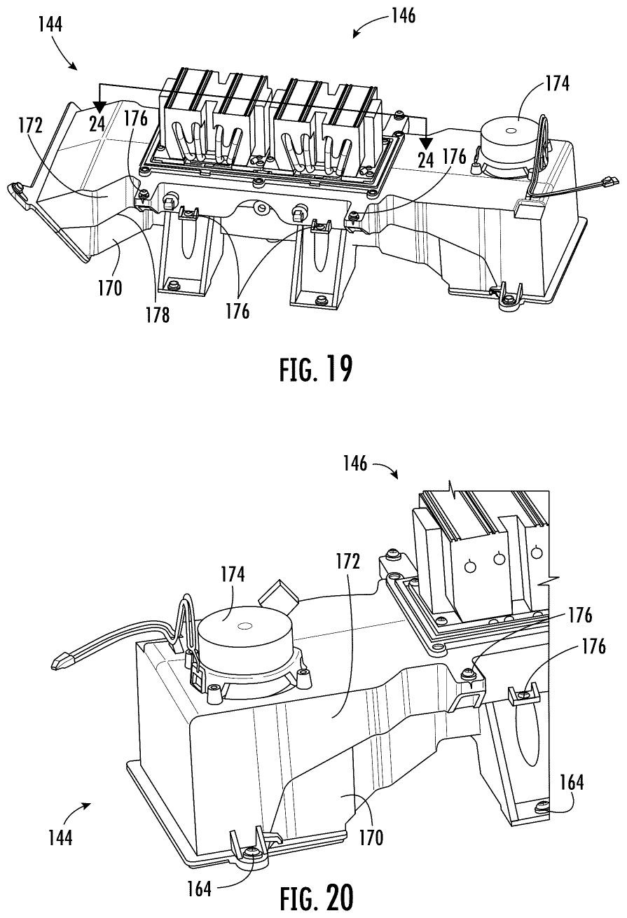

The duct portions 228, 230 are configured as separate, discrete components of the treated duct 148 and are mechanically connected together via fasteners 232 (FIGS. 15, 17, and 21) along an interface 234 (FIGS. 16, 17), which extends in a generally vertical orientation and, thus, in generally orthogonal (perpendicular) relation to the interface 178 (FIG. 19). More specifically, the duct portions 228, 230 include corresponding mounts 236, 238, respectively, which receive (spring) clips 240.

In contrast to the ambient duct 144, the treated duct 148 (e.g., the duct portions 228, 230) are insulated and include (e.g., are formed partially or entirely from) expanded polypropylene, which inhibits (if not entirely prevents) thermal loss from the treated duct 148, thereby increasing the overall efficiency of the temperature control system 112.

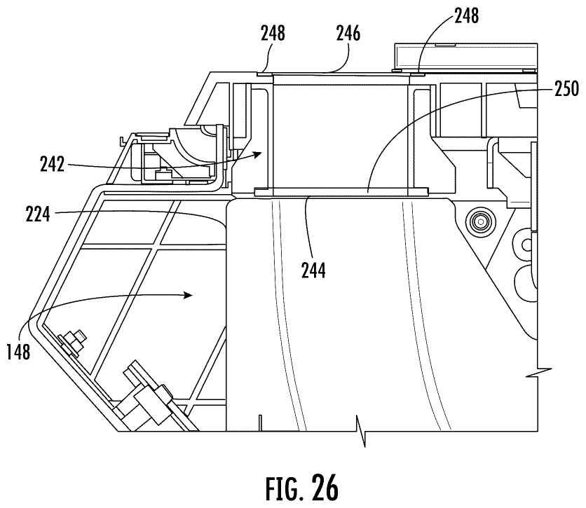

The end 224 of the treated duct 148 includes an inlet conduit 242 (FIGS. 12, 26) (also referred to as a first conduit), which extends between and (indirectly) connects the duct portions 228, 230 to the air inlet 134. More specifically, the inlet conduit 242 includes an end 244 (also referred to as a first end), which extends into the duct portions 228, 230, and an end 246 (also referred to as a second end), which is (directly) mechanically connected to the landing platform 108 (e.g., the air inlet 134) via fasteners 248 (FIG. 26).

In order to inhibit (if not entirely prevent) gapping between the inlet conduit 242 and the landing platform 108 (e.g., the air inlet 134), the temperature control system 112 includes an inlet seal 250 (FIGS. 15, 21, 26) (also referred to as an inlet damper). The inlet seal 250 is positioned (located) between and engages (contacts) the inlet conduit 242 and the treated duct 148 (e.g., the duct portions 228, 230) air inlet 134 in order to inhibit (if not entirely prevent) any loss of airflow through the treated duct 148.

In the illustrated embodiment, the end 244 of the inlet conduit 242 engages (contacts) the duct portions 228, 230 in an interference (friction) fit. Embodiments in which the end 244 of the inlet conduit 242 may be mechanically and/or adhesively connected (secured) to the duct portions 228, 230 are also envisioned herein, however.

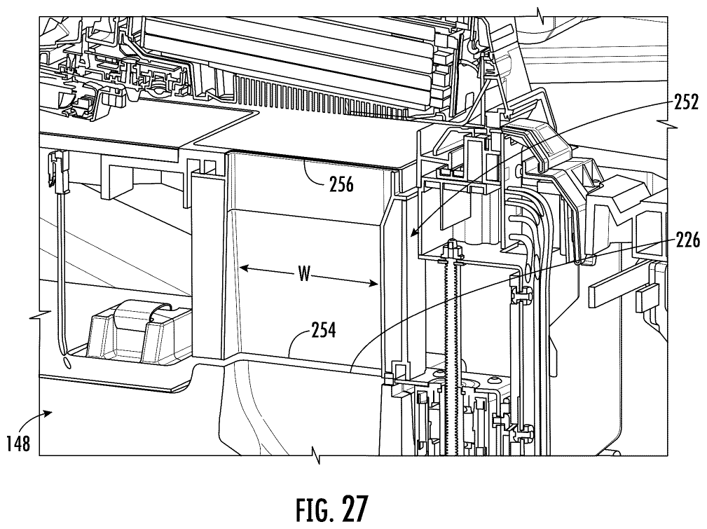

The end 226 of the treated duct 148 includes an outlet conduit 252 (FIGS. 12, 27) (also referred to as a second conduit), which extends between and (indirectly) connects the duct portions 228, 230 to the air outlet 136. More specifically, the outlet conduit 252 includes a (first) end 254, which extends into the duct portions 228, 230, and a (second) end 256, which is (directly) mechanically connected to the landing platform 108 (e.g., the air outlet 136) via fasteners 258 (FIG. 8).

As seen in FIG. 27, the outlet conduit 252 defines a width W that tapers (varies) between the ends 254, 256 thereof. More specifically, the outlet conduit 252 is configured such that the width W decreases from the end 254 towards the end 256 in order to increase the velocity of the thermally conditioned air exiting the treated duct 148 and entering the chamber 122.

In order to inhibit (if not entirely prevent) gapping between the outlet conduit 252 and the landing platform 108 (e.g., the air outlet 136), the temperature control system 112 includes an outlet seal 260 (FIGS. 15, 17) (also referred to as an outlet damper). The outlet seal 260 is positioned (located) between and engages (contacts) the outlet conduit 252 and the treated duct 148 (e.g., the duct portions 228, 230) in order to inhibit (if not entirely prevent) any loss of airflow through the treated duct 148.

In the illustrated embodiment, the end 254 of the outlet conduit 252 engages (contacts) the duct portions 228, 230 in an interference (friction) fit. Embodiments in which the end 254 of the outlet conduit 252 may be mechanically and/or adhesively connected (secured) to the duct portions 228, 230 are also envisioned herein, however.

With reference now to FIGS. 15-17 and 18, in certain embodiments, the temperature control system 112 may further include a bracket 262 (also referred to as a chassis or a scaffold). Embodiments of the temperature control system 112 that are devoid of the bracket 262 would not be beyond the scope of the present disclosure, however.

The bracket 262 supports the PCBA 214, which is (directly) mechanically connected (secured) thereto via fasteners 264 (FIG. 17) and further connects (secures together) the ambient duct 144 and the treated duct 148. More specifically, the bracket 262 extends about (e.g., spans) and receives the treated duct 148 and is (directly) mechanically connected (secured) to the ambient duct 144 via fasteners 266 (FIGS. 15, 17).

In the illustrated embodiment, the bracket 262 is configured to define a (nominal) gap with the duct portion 172 of the ambient duct 144 such that during assembly of the temperature control system 112, a spring-loading effect is created that forces the treated duct 148 and the ambient duct 144 together, thereby compressing the seal 208 (FIGS. 22, 24, 25).

The bracket 262 includes: a channel 268 (FIG. 18), which receives the treated duct 148 such that the treated duct 148 extends through the bracket 262; reliefs 270, which reduce the overall weight of the bracket 262 and, thus, the temperature control system 112; and a window 272, which receives (accommodates) the mounts 236, 238 on the treated duct 148 and the clips 240 connecting the duct portions 228, 230 together such that the mounts 236, 238 and the clips 240 extend into the cutout window 272, as seen in FIGS. 15 and 17.

With reference now to FIGS. 7, 8, 11-14, 21, and 24, methods of regulating the temperature of the UAV 10 (e.g., the power source 12 thereof) upon docking with the base station 100 will be discussed.

Upon docking of the UAV 10 with the base station 100, the intake fan 156 (FIG. 8) draws air into and directs air through the intake duct 142 and the air circuit 150 (FIG. 10) such that air flows into the compartment 120 and the chamber 122, and the fan 202 (FIG. 21) draws air into and directs air through the ambient duct 144 (FIG. 11) and the air circuit 162 such that air flows across the end 188 of the heatsink stack 146. Additionally, the fan 204 draws air within the chamber 122 (FIG. 11) into and directs air through the treated duct 148 and the air circuit 222 (FIG. 21) such that air flows across the end 190 of the heatsink stack 146 to facilitate thermal conditioning thereof, and the heatsink stack 146 (e.g., the TECs 196 (FIG. 21)) is activated by delivering power thereto.

To increase or decrease airflow through the base station 100 and/or the absorption and distribution of thermal energy by the heatsink stack 146 and, thus, the thermal conditioning of air within the treated duct 148, it is envisioned that the speed of the intake fan 156, the fan 202, and/or the fan 204 may be varied.

In various embodiments of the disclosure, it is envisioned that the monitoring, feedback, and/or adjustment of one or more parameters (e.g., current flow through the TECs 196, the speed of the intake fan 156, the fan 202, and/or the fan 204, environmental conditions, temperature, humidity, etc.), may be performed in either an open-loop control system or a closed-loop control system.

Upon activation of the heatsink stack 146, the temperatures of the ends 188, 190 thereof are varied (e.g., raised and lowered). More specifically, in the illustrated embodiment, the hot ends 198 (FIG. 24) of the TECs 196 heat the end 188 of the heatsink stack 146 and, thus, the air that is drawn into the ambient duct 144 and directed across the end 188 of the heatsink stack 146 via the fan 202. The heated air is then expelled (exhausted) from the base station 100 via the air outlet 118 (FIG. 11). Simultaneously, the cold ends 200 (FIG. 24) of the TECs 196 cool the end 190 of the heatsink stack 146 and, thus, the air that is drawn into the treated duct 148 from the chamber 122 and directed across the end 190 of the heatsink stack 146 via the fan 204, thereby thermally conditioning the air within the treated duct 148. The thermally conditioned (e.g., cooled) air is then directed through the air outlet 136 (FIGS. 7, 12, 13, 14) and into the chamber 122.

The air outlet 136 is positioned (located) on the landing platform 108 such that, upon landing of the UAV 10, the power source 12 is generally aligned with the air outlet 136, whereby the thermally conditioned (e.g., cooled) air exiting the air outlet 136 is directed across the power source 12 of the UAV 10 in order to reduce the temperature thereof.

After flowing across the power source 12 and removing heat therefrom, the air within the chamber 122 is recirculated and is drawn into the treated duct 148 via the air inlet 134 for cooling.

In the aforedescribed method, the temperature control system 112 is configured to cool the power source 12 of the UAV 10. As indicated above, however, embodiments are also envisioned in which the temperature control system 112 may be configured to heat the power source 12 of the UAV 10. For example, by reversing current flow through the TECs 196 (e.g., via the PCBA 214), the functionality of the hot ends 198 and the cold ends 200 may be reversed such that the hot ends 198 interface with (e.g., engage (contact)) the heatsinks 194 and the cold ends 200 interface with (e.g., engage (contact)) the heatsinks 192 in order to cool the end 188 of the heatsink stack 146 and heat the end 190 of the heatsink stack 146, thereby heating the air that is drawn into the treated duct 148 and circulated through the chamber 122.

To increase functionality and improve the overall operation of the base station 100, it is envisioned that the base station 100 may include a plurality of additional (ancillary) systems that are configured to address various environmental concerns (e.g., humidity, precipitation, etc.). For example, it is envisioned that the base station 100 may include (one or more) at least one heating element that is supported by the roof 104 in order to reduce the presence of snow and/or ice.

In one aspect of the present disclosure, a base station for a UAV is disclosed that includes: a body; a roof that is supported by the body; a landing platform that is supported by the body and which is configured to receive the UAV during docking; and a temperature control system.

The body includes: a first air inlet; a second air inlet; and a first air outlet.

The body and the landing platform define a compartment therebetween, and the roof and the landing platform define a chamber therebetween that is configured to accommodate the UAV upon landing.

The landing platform includes: a second air outlet; a third air inlet; and a third air outlet. The third air outlet is positioned such that, upon landing of the UAV, a power source of the UAV is generally aligned with the third outlet.

The temperature control system is positioned within the compartment and is configured to regulate a temperature of the power source of the UAV. The temperature control system includes: an intake duct that is connected to the body and which is configured to balance temperature and humidity within the base station; an ambient duct that is connected to the body; a treated duct that is operatively connected to the ambient duct; and a heatsink stack.

The intake duct includes a first end, which is in communication with the first air inlet such that air is drawn into the intake duct through the first air inlet, and a second end, which is in communication with the second air outlet such that the air exits the intake duct and enters the chamber through the second air outlet.

The ambient duct includes a first end, which is in communication with the second air inlet such that air is drawn into the ambient duct through the second air inlet, and a second end, which is in communication with the first air outlet such that the air exits the ambient duct through the first air outlet.

The treated duct includes a first end, which is in communication with the third air inlet such that the air within the chamber is drawn into the treated duct through the third air inlet to facilitate thermal conditioning thereof, and a second end, which is in communication with the third air outlet such that thermally conditioned air exits the ambient duct through the third air outlet.

The heatsink stack extends between the ambient duct and the treated duct and is configured to thermally condition the air within the treated duct.

In certain embodiments, the intake duct may include a fan that is configured to simultaneously direct air into the compartment and into the chamber to thereby balance the temperature and the humidity within the base station.

In certain embodiments, the ambient duct may be non-insulated.

In certain embodiments, the treated duct may be insulated.

In certain embodiments, the ambient duct may be configured to draw in and direct air across the heatsink stack to facilitate thermal conditioning of the air within the treated duct.

In certain embodiments, the treated duct may be configured to circulate the thermally conditioned air within the chamber to thereby regulate the temperature of the power source of the UAV.

In certain embodiments, the heatsink stack may include a first fan, which is configured to draw the air into the ambient duct, and a second fan, which is configured to draw the air into the treated duct and circulate the thermally conditioned air within the chamber.

In certain embodiments, the heatsink stack may include a first end, which extends into the ambient duct, and a second end, which extends into the treated duct.

In certain embodiments, the temperature control system may further include a first seal, which is positioned between the heatsink stack and the ambient duct, and a second seal, which is positioned between the heatsink stack and the treated duct.

In certain embodiments, the heatsink stack may further include first and second TECs that are positioned between the first end and the second end of the heatsink stack.

In certain embodiments, the first and second TECs may each be configured as a Peltier system such that upon activation of the heatsink stack, first ends of the first and second TECs are heated and second ends of the first and second TECs are cooled.

In another aspect of the present disclosure, a base station for a UAV is disclosed that includes: a body; a landing platform that is supported by the body and which is configured to receive the UAV during docking; and a temperature control system that is positioned within the body such that the temperature control system is concealed by the landing platform. The temperature control system includes: a heatsink stack having a first end and a second end; an intake duct that is connected to the body and which is configured to direct air through the base station to thereby balance temperature and humidity within the base station; an ambient duct that is connected to the heatsink stack and which is configured to direct air across the first end thereof; and a treated duct that is connected to the heatsink stack and which is configured to direct air across the second end thereof to facilitate thermal conditioning of the air within the treated duct.

In certain embodiments, the heatsink stack may extend into and between the ambient duct and the treated duct.

In certain embodiments, the temperature control system may further include a bracket that connects the treated duct and the ambient duct.

In certain embodiments, the bracket may receive the treated duct such that the treated duct extends therethrough.

In certain embodiments, the bracket may be connected to a PCBA that is configured to regulate operation of the heatsink stack.

In certain embodiments, the heatsink stack may include a first fan, which is configured to draw air into the ambient duct, and a second fan, which is configured to draw air into the treated duct.

In certain embodiments, the heatsink stack may include first and second TECs.

In certain embodiments, the first and second TECs may include first ends, which are thermally connected to the first end of the heatsink stack, and second ends, which are thermally connected to the second end of the heatsink stack.

In certain embodiments, the first and second TECs may each be configured as a Peltier system such that, upon activation of the heatsink stack, the first ends of the first and second TECs heat the first end of the heatsink stack and the second ends of the first and second TECs cool the second end of the heatsink stack.

In another aspect of the present disclosure, a base station for a UAV is disclosed that includes a temperature control system, which is configured to regulate temperature of a power source of the UAV. The temperature control system includes: a heatsink stack having a first end and a second end; an ambient duct that is connected to the heatsink stack and which defines a first air circuit that is configured to direct air across the first end of the heatsink stack; and a treated duct that is connected to the heatsink stack and which defines a second air circuit that is configured to direct air across the second end of the heatsink stack and thereby thermally condition the air.

In certain embodiments, the heatsink stack may include first and second TECs that are each configured as a Peltier system.

In certain embodiments, the first and second TECs may include first ends, which are in thermal communication with the first end of the heatsink stack, and second ends, which are in thermal communication with the second end of the heatsink stack.

In certain embodiments, the heatsink stack may further include a first fan, which is configured to draw the air into the ambient duct, and a second fan, which is configured to circulate thermally conditioned air within the treated duct.

In another aspect of the present disclosure, a method of regulating a temperature of a UAV that is docked within a base station is disclosed. The method includes: drawing air through a first air inlet in a body of the base station and into an intake duct; directing the air into the body, through the intake duct, and through a first air outlet in a landing platform of the base station such that the air enters a chamber defined between the landing platform and a roof of the base station; drawing air into an ambient duct though a second air inlet in the body; directing the air through the ambient duct, across a first end of a heatsink stack extending into the ambient duct, and through a second air outlet in the body; drawing the air in the chamber into a treated duct though a third air inlet in the landing platform; directing the air through the treated duct and across a second end of the heatsink stack extending into the treated duct to thereby thermally condition the air; and directing thermally conditioned air through a third air outlet in the landing platform and into the chamber.

In certain embodiments, directing the thermally conditioned air into the chamber may include directing the thermally conditioned air across the UAV to regulate the temperature thereof.

In certain embodiments, directing the thermally conditioned air across the UAV may include cooling the UAV.

In certain embodiments, directing the thermally conditioned air across the UAV may include heating the UAV.

In certain embodiments, drawing the air through the first air inlet may include drawing the air through the first air inlet via a fan that is configured to simultaneously direct the air into the chamber via the intake duct and into a compartment defined between the body and the landing platform to thereby balance temperature and humidity within the base station.

In certain embodiments, drawing the air into the ambient duct may include drawing the air into the ambient duct via a first fan on the heatsink stack.

In certain embodiments, drawing the air in the chamber into the treated duct may include drawing the air in the chamber into the treated duct via a second fan on the heatsink stack.

In certain embodiments, the method may further include heating first ends of TECs on the heatsink stack.

In certain embodiments, heating the first ends of the TECs may include cooling second ends of the TECs.

In certain embodiments, cooling the second ends of the TECs may include cooling the second end of the heatsink stack.

In another aspect of the present disclosure, a method of regulating a temperature of a UAV docked within a base station is disclosed. The method includes: drawing air into a first air circuit; directing the air through the first air circuit and across a first end of a heatsink stack; drawing air into a second air circuit; directing the air through the second air circuit and across a second end of a heatsink stack to thereby thermally condition the air; and directing thermally conditioned air across the UAV.

In certain embodiments, drawing air into the first air circuit may include drawing air into the first air circuit via a first fan on the heatsink stack.

In certain embodiments, drawing air into the second air circuit may include drawing air into the second air circuit via a second fan on the heatsink stack.

In certain embodiments, the method may further include activating a TEC on the heatsink stack.

In certain embodiments, activating the TEC may include heating a first end of the TEC and cooling a second end of the TEC.

In certain embodiments, heating the first end of the TEC may include heating a first end of the heatsink stack.

In certain embodiments, cooling the second end of the TEC may include cooling a second end of the heatsink stack.

In another aspect of the present disclosure, a method of regulating a temperature of a UAV docked within a base station is disclosed. The method includes: directing air through a first air circuit that receives a first end of a heatsink stack; varying a temperature of the first end of the heatsink stack; varying a temperature of a second end of the heatsink stack; directing air through a second air circuit that receives the second end of the heatsink stack to thereby thermally condition the air within the second air circuit; and directing the thermally conditioned air across the UAV.

In certain embodiments, the method may further include activating a TEC on the heatsink stack to thereby vary the temperature of the first end of the heatsink stack and the temperature of the second end of the heatsink stack.

In certain embodiments, varying the temperature of the first end of the heatsink stack may include heating the first end of the heatsink stack.

In certain embodiments, varying the temperature of the second of the heatsink stack may include cooling the second end of the heatsink stack.

Persons skilled in the art will understand that the various embodiments of the disclosure described herein and shown in the accompanying figures constitute non-limiting examples, and that additional components and features may be added to any of the embodiments discussed herein above without departing from the scope of the present disclosure. Additionally, persons skilled in the art will understand that the elements and features shown or described in connection with one embodiment may be combined with those of another embodiment without departing from the scope of the present disclosure and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the disclosure, as are alternative embodiments that may result from combining, integrating, and/or omitting features from any of the disclosed embodiments.

Use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°+25% (e.g., an angle that lies within the range of (approximately) 135° to (approximately)) 225° and the term “generally orthogonal” should be understood as referring to configurations in with the pertinent components are oriented so as to define an angle therebetween that is equal to 90°+25% (e.g., an angle that lies within the range of (approximately) 67.5° to (approximately)) 112.5°. The term “generally parallel” should thus be understood as referring to encompass configurations in which the pertinent components are arranged in parallel relation, and the term “generally orthogonal” should thus be understood as referring to encompass configurations in which the pertinent components are arranged in orthogonal relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A base station for an unmanned aerial vehicle (UAV), the base station comprising:
a body including:
a first air inlet;
a second air inlet; and
a first air outlet;
a roof supported by the body;
a landing platform supported by the body and configured to receive the UAV during docking, wherein the body and the landing platform define a compartment therebetween, and the roof and the landing platform define a chamber therebetween configured to accommodate the UAV upon landing, wherein the landing platform includes:
a second air outlet;
a third air inlet; and
a third air outlet, wherein the third air outlet is positioned such that, upon landing of the UAV, a power source of the UAV is generally aligned with the third air outlet; and
a temperature control system positioned within the compartment and configured to regulate a temperature of the power source of the UAV, wherein the temperature control system includes:
an intake duct connected to the body, wherein the intake duct is configured to balance temperature and humidity within the base station and includes:
a first end in communication with the first air inlet such that air is drawn into the intake duct through the first air inlet; and
a second end in communication with the second air outlet such that the air exits the intake duct and enters the chamber through the second air outlet;
an ambient duct connected to the body and including:
a first end in communication with the second air inlet such that air is drawn into the ambient duct through the second air inlet; and
a second end in communication with the first air outlet such that the air exits the ambient duct through the first air outlet;
a treated duct operatively connected to the ambient duct and including:
a first end in communication with the third air inlet such that the air within the chamber is drawn into the treated duct through the third air inlet to facilitate thermal conditioning thereof; and
a second end in communication with the third air outlet such that thermally conditioned air exits the ambient duct through the third air outlet; and
a heatsink stack extending between the ambient duct and the treated duct, wherein the heatsink stack is configured to thermally condition the air within the treated duct.

2. The base station of claim 1, wherein the intake duct includes a fan configured to simultaneously direct air into the compartment and into the chamber.

3. The base station of claim 1, wherein the ambient duct is non-insulated, and the treated duct is insulated.

4. The base station of claim 1, wherein the ambient duct is configured to draw in and direct air across the heatsink stack to facilitate thermal conditioning of the air within the treated duct.

5. The base station of claim 1, wherein the treated duct is configured to circulate the thermally conditioned air within the chamber to thereby regulate the temperature of the power source of the UAV.

6. The base station of claim 1, wherein the heatsink stack includes:
a first fan configured to draw the air into the ambient duct; and
a second fan configured to draw the air into the treated duct and circulate the thermally conditioned air within the chamber.

7. The base station of claim 1, wherein the heatsink stack includes:
a first end extending into the ambient duct; and
a second end extending into the treated duct.

8. The base station of claim 7, wherein the temperature control system further includes:
a first seal positioned between the heatsink stack and the ambient duct; and
a second seal positioned between the heatsink stack and the treated duct.

9. The base station of claim 7, wherein the heatsink stack further includes:
first and second thermoelectric conditioners (TECs) positioned between the first end and the second end of the heatsink stack.

10. The base station of claim 9, wherein the first and second TECs are each configured as a Peltier system such that upon activation of the heatsink stack, first ends of the first and second TECs are heated and second ends of the first and second TECs are cooled.

11. A base station for an unmanned aerial vehicle (UAV), the base station comprising:
a body;
a landing platform supported by the body and configured to receive the UAV during docking; and
a temperature control system positioned within the body such that the temperature control system is concealed by the landing platform, wherein the temperature control system includes:
a heatsink stack having a first end and a second end;
an intake duct connected to the body and configured to direct air through the base station to thereby balance temperature and humidity within the base station;
an ambient duct connected to the heatsink stack and configured to direct air across the first end thereof; and
a treated duct connected to the heatsink stack and configured to direct air across the second end thereof to facilitate thermal conditioning of the air within the treated duct.

12. The base station of claim 11, wherein the heatsink stack extends into and between the ambient duct and the treated duct.

13. The base station of claim 11, wherein the temperature control system further includes:
a bracket connecting the treated duct and the ambient duct, wherein the bracket receives the treated duct such that the treated duct extends therethrough.

14. The base station of claim 13, wherein the bracket is connected to a printed circuit board assembly is configured to regulate operation of the heatsink stack.

15. The base station of claim 11, wherein the heatsink stack includes:
a first fan configured to draw air into the ambient duct; and
a second fan configured to draw air into the treated duct.

16. The base station of claim 11, wherein the heatsink stack includes:
first and second thermoelectric conditioners (TECs) including first ends thermally connected to the first end of the heatsink stack and second ends thermally connected to the second end of the heatsink stack.

17. The base station of claim 16, wherein the first and second TECs are each configured as a Peltier system such that, upon activation of the heatsink stack, the first ends of the first and second TECs heat the first end of the heatsink stack and the second ends of the first and second TECs cool the second end of the heatsink stack.

18. A base station for an unmanned aerial vehicle (UAV), the base station comprising:
a temperature control system configured to regulate temperature of a power source of the UAV, the temperature control system including:
a heatsink stack having a first end and a second end;
an ambient duct connected to the heatsink stack, wherein the ambient duct defines a first air circuit configured to direct air across the first end of the heatsink stack; and
a treated duct connected to the heatsink stack, wherein the treated duct defines a second air circuit configured to direct air across the second end of the heatsink stack and thereby thermally condition the air.

19. The base station of claim 18, wherein the heatsink stack includes:
first and second thermoelectric conditioners (TECs) each configured as a Peltier system, wherein the first and second TECs include first ends in thermal communication with the first end of the heatsink stack and second ends in thermal communication with the second end of the heatsink stack.

20. The base station of claim 19, wherein the heatsink stack further includes:
a first fan configured to draw the air into the ambient duct; and
a second fan configured to circulate thermally conditioned air within the treated duct.
